(19) United States
(12) Patent Application Publication
(10) Pub. No.: US 2017/0139944 A1
(43) Pub. Date: May 18, 2017

(54) METHOD, DEVICE AND COMPUTER-READABLE MEDIUM FOR MONITORING A FILE IN SYSTEM PARTITION

(71) Applicant: Xiaomi Inc., Beijing (CN)

(72) Inventors: Minghao LI, Beijing (CN); Le WANG, Beijing (CN); Ruixian ZHU, Beijing (CN)

(73) Assignee: Xiaomi Inc., Beijing (CN)

(21) Appl. No.: 15/136,273

(22) Filed: Apr. 22, 2016

(30) Foreign Application Priority Data
Nov. 13, 2015 (CN) 201510780666.8

(51) Int. Cl. G06F 17/30; G06F 9/445; G06F 11/14; H04W 4/06; G06F 21/62

(52) U.S. Cl. CPC G06F 17/30144; G06F 17/30082; G06F 17/30117; H04W 4/06; G06F 21/6209; G06F 11/1464; G06F 8/65; G06F 2201/84

(57) ABSTRACT

Method, device and computer-readable medium for monitoring a file in a system partition are provided in the disclosure. The method is applied in a mobile terminal, including: initiating a monitoring service for a file in a system partition, generating a listening thread related to the monitoring service to listen for an input event with respect to a target system partition, the input event being a manipulation of a file in the target system partition, and recording the input event into a log file when the input event with respect to the target system partition has been listened in the listening thread. In the disclosure, by creating a listening thread to listen a file in a target system partition, and then recording any input event occurred for the file in the target system partition, it is capable of knowing what kind of manipulation has been done to the file in the target system partition by other software.

### CROSS-REFERENCE TO RELATED APPLICATION

This application claims priority to Chinese Patent Application No. 201510780666.8, filed Nov. 13, 2015, which is incorporated herein by reference in its entirety.

### FIELD

The present disclosure generally relates to method, device and computer-readable medium for monitoring a file in system partition.

### BACKGROUND

A smart mobile terminal's Operation System such as Android system frequently has a requirement for upgrade. At present, the version upgrade of the mobile terminal's operation system is usually implemented through Over-the-Air (OTA) technology. However, errors such as an upgrade failure often occur at the time of performing an OTA version upgrade. Mostly, the occurrences of these errors are resulted from a fact that a file(s) in a system partition of the mobile terminal's operating system has been accidently modified or been tampered with by a third-party software. As a result, some system files may be incomplete, lost, or a new file may be added. Accordingly, the system upgrade cannot be performed normally.

### SUMMARY

In view of the fact in related arts, a method, device and computer-readable medium for monitoring a file in a system partition are provided in the disclosure.

According to a first aspect of the present disclosure, there is provided a method for monitoring a file in a system partition. The method includes initiating a monitoring service for a file in a system, generating a listening thread related to the monitoring service to listen for an input event with respect to a target system partition, the input event being a manipulation of a file in the target system partition, listening, by the listening thread, the input event with respect to the operating system partition, classifying the listened input event, and performing security processing on the file in the operating system partition based on the classification of the listened input event.

According to a second aspect of embodiments of the present disclosure, a device for monitoring a file in a system partition is provided. The device includes an initiating module configured to initiate a monitoring service, a listening module configured to generate a listening thread related to the monitoring service to listen for an input event with respect to a target system partition, the input event being a manipulation of a file in the target system partition, and a recording module configured to record the input event into a log file when the input event with respect to the target system partition has been listened in the listening thread.

According to a third aspect of embodiments of the present disclosure, there is provided an apparatus for monitoring a file in a system partition, including a processor, a memory for storing instructions executable by the processor. The processor is configured to: initiate a monitoring service, generate a listening thread related to the monitoring service to listen for an input event with respect to a target system partition, the input event being a manipulation of a file in the target system partition, and record the input event into a log file when the input event with respect to the target system partition has been listened in the listening thread.

According to a fourth aspect of embodiments of the present disclosure, there is provided a non-transitory computer readable storage medium having stored instructions therein, which when executed by a processor of a mobile terminal, enable the mobile terminal to perform a method for monitoring a file in a system partition. The method includes initiating a monitoring service, generating a listening thread related to the monitoring service to listen for an input event with respect to a target system partition, the input event being a manipulation of a file in the target system partition, and recording the input event into a log file when the input event with respect to the target system partition has been listened in the listening thread.

It is to be understood that both the forgoing general description and the following detailed description are exemplary only, and are not restrictive of the present disclosure.

### BRIEF DESCRIPTION OF THE DRAWINGS

The accompanying drawings, which are incorporated in and constitute a part of this specification, illustrate embodiments consistent with the invention and, together with the description, serve to explain the principles of the invention.

FIG. 1 is a flow diagram illustrating a method for monitoring a file in a system partition according to an exemplary embodiment.

FIG. 2 is a flow diagram illustrating a method for monitoring a file in a system partition according to another exemplary embodiment.

FIG. 3 is a flow diagram illustrating a method for monitoring a file in a system partition according to another exemplary embodiment.

FIG. 4 is a block diagram illustrating a device for monitoring a file in a system partition according to an exemplary embodiment.

FIG. 5 is a block diagram illustrating a device for monitoring a file in a system partition according to another exemplary embodiment.

FIG. 6 is a block diagram illustrating a classification and security processing module according to an exemplary embodiment.

FIG. 7 is a block diagram illustrating a device for monitoring a file in a system partition according to an exemplary embodiment.

FIG. 8 is a block diagram illustrating a device for monitoring a file in a system partition according to an exemplary embodiment.

### DETAILED DESCRIPTION

Reference will now be made in detail to exemplary embodiments, examples of which are illustrated in the accompanying drawings. The following description refers to the accompanying drawings in which same numbers in different drawings represent same or similar elements unless otherwise described. The implementations set forth in the following description of exemplary embodiments do not represent all implementations consistent with the invention. Instead, they are merely examples of devices and methods consistent with aspects related to the invention as recited in the appended claims.

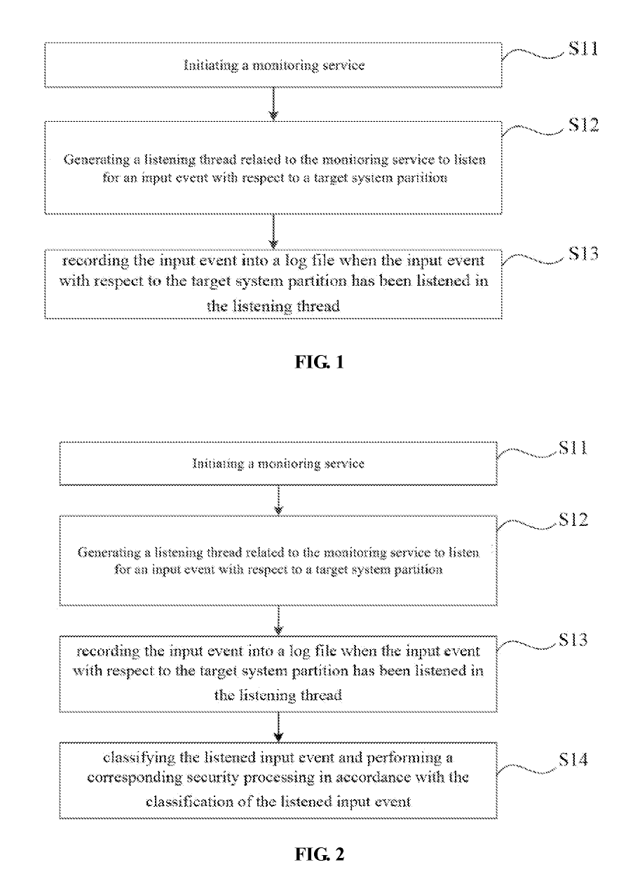

FIG. 1 is a flow diagram illustrating a method for monitoring a file in a system partition according to an exemplary embodiment. As illustrated in FIG. 1, the method for monitoring a file in a system partition may be applied in a mobile terminal, and may include the following steps: in step S11, initiating a monitoring service; in step S12, creating a listening thread in the monitoring service to listen for an input event with respect to a target system partition; in step S13, when the input event with respect to the target system partition has been listened in the listening thread, recording the input event into a log file. The above steps will be illustrated below with more details.

In step S11, a monitoring service is initiated. In one embodiment, the monitoring service is initiated during a system booting of the mobile terminal. In this way, all the variations happened in the file of the target system partition can be completely recorded.

In step S12, a listening thread related to the monitoring service is generated. For example, in a Android system based on Linux, a FileObserver Class may be used to generate the listening thread. The FileObserver Class is an observer for listening for manipulations such as access, creation, modification, deletion, or movement of a file. This observer may observe a individual file or a file folder. If a file folder is being observed, then all the files and cascaded subdirectories within the file folder will be observed. In the present disclosure, the generated listening thread is used to listen or observe the target system partition, which is directed to a file folder(s) corresponding to the Operating System partition in the Android system.

Subsequently, the generated listening thread may be used to listen for an input event with respect to the target system partition. In the Android system, for example, this may be observed by a so called “inotify” mechanism in Linux.

Herein, the input event may be a kind of manipulation of a file in the target system partition. Specifically, the input event may include, but not limited to, at least one of: file creation (CREAT), file modification (MODIFY), file deletion (DELETE), and file movement (MOVE).

In step S13, when the input event with respect to the target system partition has been listened in the listening thread, the input event, such as file A being amended by program XX into . . . , or file B being deleted by program XX, etc, is recorded into a log file. Specifically, if another program performs such input event to a file in the target system partition, then the above input event may have been listened and recorded by a listening program. Accordingly, all the variations happened to files in the target system partition may be logged, and based on the log file, when performing an OTA system version upgrade thereafter, it is capable of knowing whether there exists any defects, modifications in the files of the target system partition. In turn, the defected or modified files may be repaired specifically.

Alternatively or additionally, the listened input event may be classified in the present disclosure. FIG. 2 is a flow diagram illustrating a method for monitoring a file in a system partition according to another exemplary embodiment. Steps S11, S12, and S13 shown in the figure are same as those in FIG. 1. Moreover, this method may further include: in step S14, classifying the listened input event and performing a corresponding security processing in accordance with the classification of the listened input event.

Different security handlings may be performed for different kinds of input events, depending on risks possibly generated by these input events. Some possible security handlings are listed as below, although those skilled in the art may appreciate that the means for security processing is not limited thereto.

Regarding input events belonging to a classification of file creation (CREAT), besides being recorded, a created file may be deleted.

Regarding input events belonging to a classification of file modification (MODIFY), file deletion (DELETE), or file movement (MOVE), these kinds of manipulations will not be stopped, except for being recorded. However, it is also possible to precede following security processing.

When the listened input event is an event of file modification or file movement, it is determined whether the input event satisfies a preconfigured condition for reporting. If the preconfigured condition is satisfied, then a report message will be sent. The preconfigured condition for reporting may be, for example, the input event being performed by a certain program (e.g., some baleful program). At this time, the mobile terminal's user may be prompted (i.e., the report message is sent out). Alternatively, the report message may be sent to a server such that the server determines if it is necessary to stop or restore the input event.

When the listened input event is an event of file modification or file deletion, a file before the modification or deletion may be backed up. This is for the purpose of keeping the original file, and thus in case that this file has been maliciously deleted or modified such that the system upgrade cannot be performed for the file being defected, the original file may be retrieved directly within the mobile terminal for system upgrade.

In an alternative implementation of this embodiment, the original file may not be kept, to avoid unnecessary storage of too much useless data. In this implementation, when the listened input event is an event of file deletion, a file restoration request is sent in response to an access request for a deleted file. The file restoration request may be used for requesting to send the deleted file. If it is necessary for the system upgrade, an access request for the deleted file will be generated. At this time, the mobile terminal may send a file restoration request to a server, and the server in turn may resend the deleted file to the mobile terminal for file restoration. Accordingly, the system upgrade may be performed successfully.

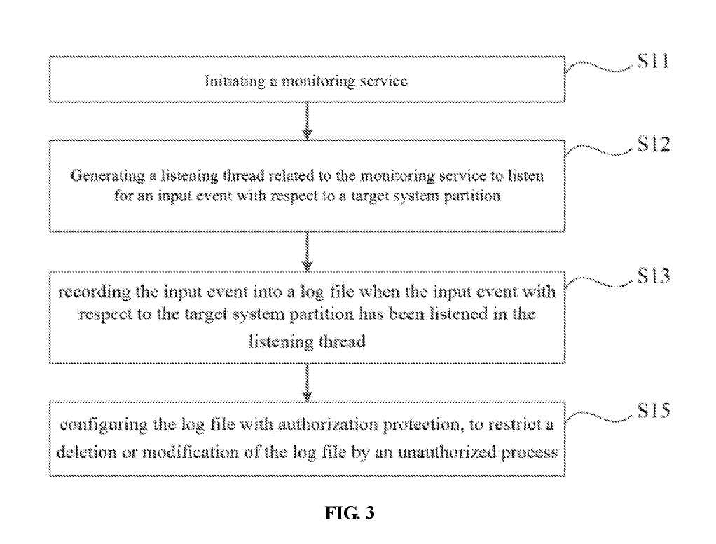

As shown in FIG. 3, which depicts a flow diagram illustrating a method for monitoring a file in a system partition according to another exemplary embodiment, the steps S11, S12, S13 are the same as those of FIG. 1. Other than this, the disclosure also provides a mechanism for preventing a manipulation or deletion of a log file recording input events. The method may further include: in step S15, configuring the log file with authorization protection, to restrict a deletion or modification of the log file by an unauthorized process. In this way, even if some process may have a root privilege (a supervisor privilege), this process cannot delete or modify the log file. With respect to a system based on Linux, a Security-Enhanced Linux (SELinux) authorization protection may be used.

In this embodiment, authorized processes may be defined by the system. For example, the listening thread may be defined as an authorized process.

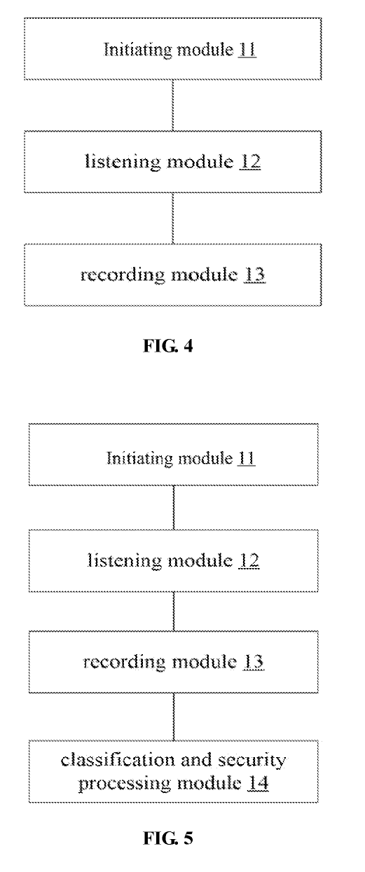

FIG. 4 is a block diagram illustrating a device for monitoring a file in a system partition according to an exemplary embodiment. Referring to FIG. 4, the device may include an initiating module 11, a listening module 12 and a recording module 13.

The initiating module 11 is configured to initiate a monitoring service. In one embodiment, the initiating module 11 may initiate the monitoring service during a system booting of the mobile terminal.

The listening module 12 is configured to generate a listening thread related to the monitoring service to listen for an input event with respect to a target system partition. The input event is a manipulation of a file in the target system partition.

The recording module 13 is configured to record the input event into a log file when the input event with respect to the target system partition has been listened in the listening thread. The input event may include at least one of file creation, file modification, file deletion, and file movement.

FIG. 5 is a block diagram illustrating a device for monitoring a file in a system partition according to another exemplary embodiment. Except for the structure shown in FIG. 4, the device may further include a classification and security processing module 14 configured to classify the listened input event and perform a corresponding security processing in accordance with the classification of the listened input event.

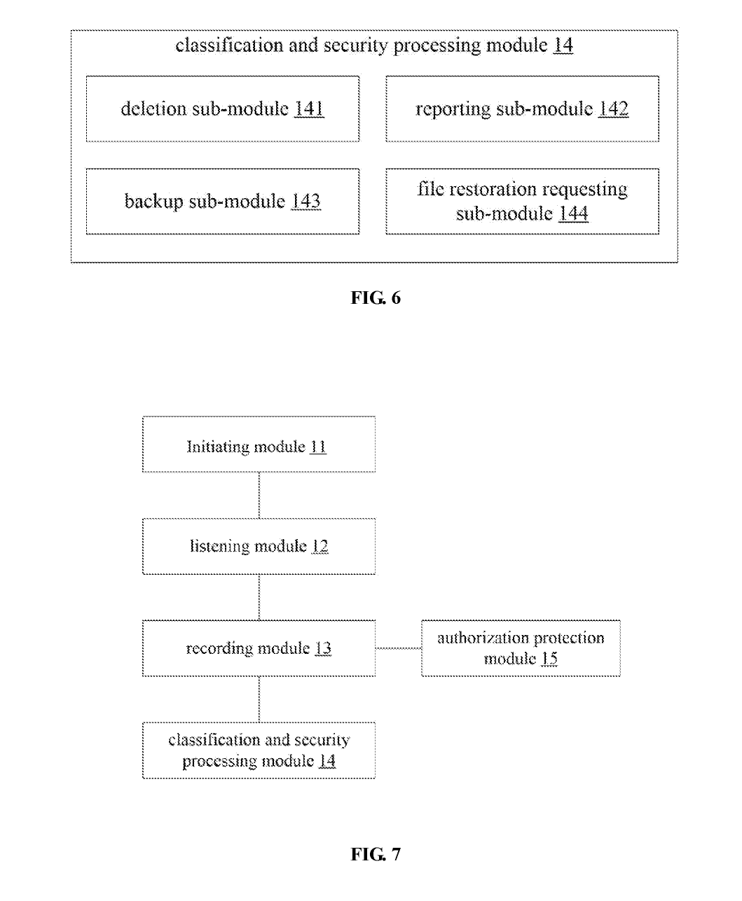

According to one implementation, as shown in FIG. 6, a block diagram illustrating a classification and security processing module 14 according to an exemplary embodiment is provided. The classification and security processing module 14 may include at least one of: a deletion sub-module 141 configured to delete, in case of the listened input event being an event of file creation, a created file, a reporting sub-module 142 configured to determine, in case of the listened input event being an event of file modification or file movement, whether the input event satisfies a preconfigured condition for reporting and send a report message when the preconfigured condition is satisfied, a backup sub-module 143 configured to backup, in case of the listened input event being an event of file modification or file deletion, a file before the modification or deletion, and a file restoration requesting sub-module 144 configured to send, in case of the listened input event being an event of file deletion, a file restoration request when an access request for a deleted file is received, the file restoration request requesting to send the deleted file.

Moreover, according to another implementation, as shown in FIG. 7, the device may further include an authorization protection module 15 configured to configure the log file with authorization protection, to restrict the deletion or modification of the log file by an unauthorized thread.

With respect to the devices in the above embodiments, the specific manners that the respective modules perform operations have been described in detail in the embodiments regarding the relevant methods, and will not be elaborated herein.

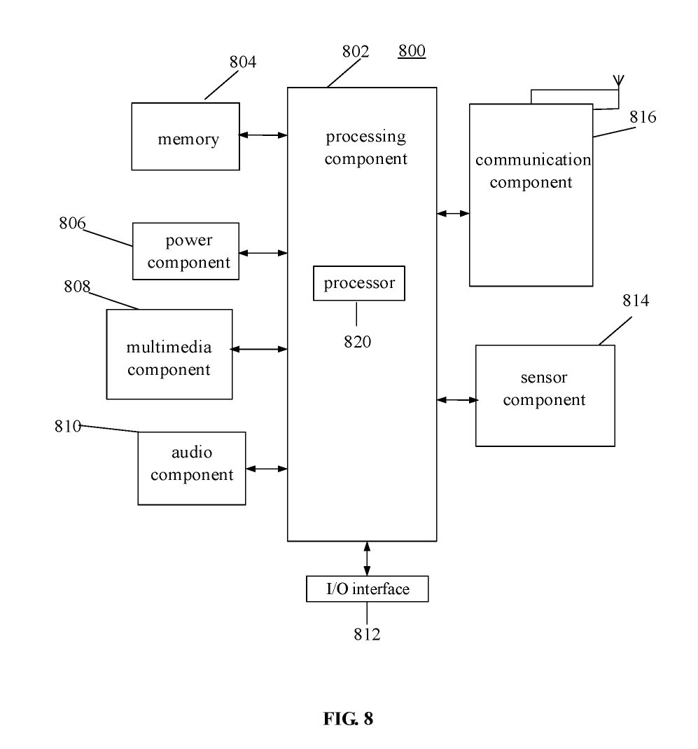

FIG. 8 is a block diagram of an device 100 for monitoring a file in a system partition according to an exemplary embodiment. For example, the device 100 may be a mobile phone, a computer, a digital broadcast terminal, a messaging device, a gaming console, a tablet, a medical device, an exercise equipment, a personal digital assistant, and the like.

Referring to FIG. 8, the device 100 may include one or more of the following components: a processing component 102, a memory 104, a power component 106, a multimedia component 108, an audio component 110, an input/output (I/O) interface 112, a sensor component 114, and a communication component 116.

The processing component 102 typically controls overall operations of the device 100, such as the operations associated with display, telephone calls, data communications, camera operations, and recording operations. The processing component 102 may include one or more processors 120 to execute instructions to perform all or part of the steps in the above described methods. Moreover, the processing component 102 may include one or more modules which facilitate the interaction between the processing component 102 and other components. For instance, the processing component 102 may include a multimedia module to facilitate the interaction between the multimedia component 108 and the processing component 102.

The memory 104 is configured to store various types of data to support the operation of the device 100. Examples of such data include instructions for any applications or methods operated on the device 100, contact data, phonebook data, messages, pictures, video, etc. The memory 104 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 106 provides power to various components of the device 100. The power component 106 may include a power management system, one or more power sources, and any other components associated with the generation, management, and distribution of power for the device 100.

The multimedia component 108 includes a screen providing an output interface between the device 100 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 108 includes a front camera and/or a rear camera. The front camera and the rear camera may receive an external multimedia datum while the device 100 is in an operation mode, such as a photographing mode or a video mode. Each of the front camera and the rear camera may be a fixed optical lens system or have optical focusing and zooming capability.

The audio component 110 is configured to output and/or input audio signals. For example, the audio component 110 includes a microphone (“MIC”) configured to receive an external audio signal when the device 100 is in an operation mode, such as a call mode, a recording mode, and a voice recognition mode. The received audio signal may be further stored in the memory 104 or transmitted via the communication component 116. In some embodiments, the audio component 110 further includes a speaker to output audio signals.

The I/O interface 112 provides an interface between the processing component 102 and peripheral interface modules, the peripheral interface modules being, for example, a keyboard, a click wheel, buttons, and the like. The buttons may include, but are not limited to, a home button, a volume button, a starting button, and a locking button.

The sensor component 114 includes one or more sensors to provide status assessments of various aspects of the device 100. For instance, the sensor component 114 may detect an open/closed status of the device 100, relative positioning of components (e.g., the display and the keypad, of the device 100), a change in position of the device 100 or a component of the device 100, a presence or absence of user contact with the device 100, an orientation or an acceleration/deceleration of the device 100, and a change in temperature of the device 100. The sensor component 114 may include a proximity sensor configured to detect the presence of a nearby object without any physical contact. The sensor component 114 may also include a light sensor, such as a CMOS or CCD image sensor, for use in imaging applications. In some embodiments, the sensor component 114 may also include an accelerometer sensor, a gyroscope sensor, a magnetic sensor, a pressure sensor, or a temperature sensor.

The communication component 116 is configured to facilitate communication, wired or wirelessly, between the device 100 and other devices. The device 100 can access a wireless network based on a communication standard, such as WiFi, 2G or 3G; or a combination thereof. In an exemplary embodiment, the communication component 116 receives a broadcast signal or broadcast associated information from an external broadcast management system via a broadcast channel. In an exemplary embodiment, the communication component 116 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In exemplary embodiments, the device 100 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In exemplary embodiments, there is also provided a non-transitory computer-readable storage medium including instructions, such as included in the memory 104, executable by the processor 120 in the device 100, for performing the above-described methods. For example, the non-transitory computer-readable storage medium may be a ROM, a RAM, a CD-ROM, a magnetic tape, a floppy disc, an optical data storage device, and the like.

Each module discussed above, such as the initiating module 11, the listening module 12 and the recording module 13, may take the form of a packaged functional hardware unit designed for use with other components, a portion of a program code (e.g., software or firmware) executable by the processor or the processing circuitry that usually performs a particular function of related functions, or a self-contained hardware or software component that interfaces with a larger system, for example.

Other embodiments of the invention will be apparent to those skilled in the art from consideration of the specification and practice of the disclosures herein. This application is intended to cover any variations, uses, or adaptations of the disclosure following the general principles thereof and including such departures from the present disclosure as come within known or customary practice in the art. It is intended that the specification and examples be considered as exemplary only, with a true scope and spirit of the invention being indicated by the following claims.

It will be appreciated that the inventive concept is not limited to the exact construction that has been described above and illustrated in the accompanying drawings, and that various modifications and changes can be made without departing from the scope thereof. It is intended that the scope of the invention only be limited by the appended claims.

What is claimed is:

1. A method for monitoring a file in a system partition in a smart device, comprising:
initiating a monitoring service for a file in a system partition;
generating a listening thread related to the monitoring service, the input event being a manipulation of a file in the operating system partition;
listening, by the listening thread, the input event with respect to the operating system partition;
classifying the listened input event; and
performing security processing on the file in the operating system partition based on the classification of the listened input event.

2. The method of claim 1, wherein the monitoring service is initiated during a system booting of the smart device.

3. The method of claim 1, wherein the input event comprises at least one of file creation, file modification, file deletion, and file movement.

4. The method of claim 1, further comprising:
recording the input event into a log file when the input event with respect to the operating system partition has been listened in the listening thread.

5. The method of claim 1, wherein the performing security processing comprises at least one of:
deleting a created file when the listened input event is an event of file creation;
determining whether the input event satisfies a preconfigured condition for reporting when the listened input event is an event of file modification or file movement, and sending a report message when the preconfigured condition is satisfied;
backing up a file before the file is modified or deleted when the listened input event is an event of file modification or file deletion; and
sending a file restoration request to a server when an access request for a deleted file is received and the listened input event is an event of file deletion, the file restoration request requesting to send the deleted file.

6. The method of claim 4, further comprising:
configuring the log file with authorization protection to restrict a deletion or modification of the log file by an unauthorized process.

7. The method of claim 6, wherein the configuring comprises:
configuring the log file with Security-Enhanced Linux (SELinux) authorization protection.

8. The method of claim 4, further comprising:
configuring the log file with authorization protection to restrict a deletion or modification of the log file by an unauthorized process.

9. The method of claim 4, further comprising:
configuring the log file with authorization protection to restrict a deletion or modification of the log file by an unauthorized process.

10. The method of claim 5, wherein backing up a file comprises sending the file to a server.

11. The method of claim 1, wherein the monitoring service is initiated during an upgrade of an operating system of the smart device through Over-the-air (OTA).

12. A device for monitoring a file in a system partition in a smart device, comprising:
a processor;
a memory for storing instructions executable by the processor,
wherein the processor is configured to:
initiate a monitoring service for a file in a system partition;
generate a listening thread related to the monitoring service, the input event being a manipulation of a file in the target system partition;
listen, through the listening thread, the input event with respect to the operating system partition;
classify the listened input event; and
perform security processing on the file in the operating system partition based on the classification of the listened input event.

13. The device of claim 12, wherein the monitoring service is initiated during a system booting of the smart device.

14. The device of claim 12, wherein the input event includes at least one of file creation, file modification, file deletion, and file movement.

15. The device of claim 14, wherein the processor is further configured to:
record the input event into a log file when the input event with respect to the operating system partition has been listened in the listening thread.

16. The device of claim 15, wherein the processor is further configured to perform at least one of the following steps:
deleting a created file when the listened input event is an event of file creation;
determining whether the input event satisfies a preconfigured condition for reporting when the listened input event is an event of file modification or file movement, and sending a report message when the preconfigured condition is satisfied;
backing up a file before the file is modified or deleted when the listened input event is an event of file modification or file deletion; and
sending a file restoration request to a server when an access request for a deleted file and the listened input event is an event of file deletion, the file restoration request requesting to send the deleted file.

17. The device of claim 12, wherein the processor is further configured to:
configure the log file with authorization protection to restrict the deletion or modification of the log file by an unauthorized process.

18. The device of claim 17, wherein the authorization protection is Security-Enhanced Linux (SELinux) authorization protection.

19. A non-transitory computer-readable storage medium having stored therein instructions that, when executed by a processor of a device, cause the device to perform
initiating a monitoring service for a file in a system partition;
generating a listening thread related to the monitoring service, the input event being a manipulation of a file in the operating system partition;
listening, by the listening thread, the input event with respect to the operating system partition;
classifying the listened input event; and
performing security processing on the file in the operating system partition based on the classification of the listened input event.
